(19) United States
(12) Patent Application Publication
(10) Pub. No.: US 2015/0041730 A1
(43) Pub. Date: Feb. 12, 2015

(54) CARBON NANOTUBE - POLYSACCHARIDE COMPOSITE

(71) Applicant: Veijo KANGAS, (US)

(72) Inventors: Veijo Kangas, Jyvaskyla (FI); Jorma Virtanen, Las Vegas, NV (US); Pasi Moilanen, Jyvaskyla (FI)

(21) Appl. No.: 14/394,014

(22) PCT Filed: Apr. 11, 2013
(86) PCT No.: PCT/FI2013/000019

§ 371 Date: Oct. 10, 2014

Related U.S. Application Data
(60) Provisional application No. 61/686,660, filed on Apr. 11, 2012.
(60) Provisional application No. 61/850,560, filed on Feb. 20, 2013.

(30) Foreign Application Priority Data
Apr. 23, 2012 (FI) 20120129
Apr. 23, 2012 (FI) 20120130

(51) Int. Cl. C09D 5/24; C08B 15/00; F28F 21/02

(52) U.S. Cl. CPC C09D 5/24; F28F 21/02; C08B 15/00; F28F 2245/00
USPC 252/511; 252/510; 127/34

(57) ABSTRACT

The present invention provides methods for the fabrication CNT dispersions using polysaccharides, especially hemicelluloses, and most advantageously xylan.

The present invention also provides methods to isolate, and purify hemicelluloses from plant materials.

The present invention provides methods and compositions for the coating of solid surfaces using CNT dispersions.

One currently preferred method coating of a surface is electrospraying the CNT dispersion.

The present invention provides electrically conducting materials that can replace conducting plastics, graphite, and even some metals as electrical conductors.

In one embodiment the present materials can be used as stealth coatings.

In another embodiment the present materials can provide shield against high frequency electromagnetic radiation, while being permeable to low frequency magnetic field.

In one specific application the dispersion fabricated from double walled carbon nanotubes (DWNTs), and xylan can be used to fabricate transparent electrically conducting films.

In one embodiment of the present invention the surface films will be cross-linked, and these films can be used in multiple applications including supercapacitors.

### FIELD OF THE INVENTION

The present invention provides materials, and their fabrication methods for electrically conducting coatings. More specifically the fabrication of carbon nanotube-polysaccharide dispersions is described.

### PRIOR ART

CARBON NANOTUBES (CNTs) can be single walled (SWNT), double walled (DWNT), or multi walled (MWNT). They have wide variety of applications, because they have remarkable electronic and mechanical properties. Coiled CNTs can be fabricated in fairly pure form. They have good EMI shielding values. SWNTs are often grown on a solid macroscopic surface. The distribution of SWNTs can be controlled in the “forest”. It is very difficult to transfer these structures onto other surfaces. In most applications good dispersion of CNTs is fundamentally important. CNTs can be dispersed using mechanical, ultrasonic, or hydrodynamic energy. There is a limit for the use of energy, because the CNTs may be damaged.

Dispersion may initially be good, but the CNTs recombine during storage. Recombination may be slowed down by high viscosity of the medium. However, high viscosity slows down the dispersion especially, when ultrasonic dispersion will be used. The dispersion may be so slow that most, perhaps all, industrial scale applications will be impractical.

Often the dispersed material will be spread on a solid surface. Then common coating requirements will be important. These include binding with the surface, abrasion, and cracking resistance. Especially, if the coating is applied for the fabrication of flexible electronics, cracking would be a major problem. In addition to common requirements, the present invention provides increased control of the separation and orientation of the CNTs. The present invention will solve most of the problems associated with the CNT dispersions and their applications.

Detergents, such as sodium dodecylsulfate (SDS), tween, triton, and octyl glucoside have been commonly used for dispersion.

The use of cellulose, and many modified celluloses, like nano cellulose, and carboxymethyl cellulose for the dispersion of CNTs is well known in-the-art (Moilanen and Virtanen, PCT/FI10/00077). Recently we observed that various filtrates that are formed during the fabrication of pulp and paper have good dispersion properties for the CNTs. It was concluded that hemicelluloses were the active species. However, hemicellulose was not characterized. After studying numerous polysaccharides, and hemicelluloses, it has become apparent that the best hemicellulose for dispersion of CNTs is xylan. During these studies also structure-function relationship has become obvious.

Many microorganisms produce exopolysaccharides. The possible reason is to produce gel-like surroundings that will protect the microorganism. Exopolysaccharides can be used for the dispersion of the CNTs, and stabilization of dispersions. These include in alphabetical order: acetan, alginate, chitosan, curdlan, cyclosophoran, dextran, emulsan, galactoglucopolysaccharide, gellan, glucuronan, N-acetyl-heparosan, hyaluronic acid, kefiran, lentinan, levan, pullulan, scleroglucan, schizophyllan, stewartan, succinoglycan, welan, and xanthan. Although some of these can be used for the dispersion of CNTs, it is more advantageous to use them for the stabilization of the CNT dispersions.

### DETAILED DESCRIPTION OF THE PRESENT INVENTION

The present invention allows the dispersion of CNTs and graphene using certain polysaccharides without detergents. These polysaccharides bind CNTs almost quantitatively and coat CNTs with a thin molecular layer. If the dispersion is done correctly according to this invention, the concentration of CNTs can be higher than with other known methods (up to 8%), and the viscosity of the dispersion will still be relatively low. CNTs are separated from each other, and these dispersions are stable indefinitely. These facts provide several advantages over conventional dispersions. CNTs are coated with a monolayer of a polysaccharide. These polysaccharides will be strongly hydrated in water and will make CNTs soluble in water. Because they are wound around a cylindrical CNT surface, their mutual interaction is weak. The weak interaction between polysaccharide coated CNTs allow their orientation using various fields, including magnetic, electric, and shear force fields. Because concentrations can be relatively high, fairly small amount of dispersion will be needed to coat surfaces. Because solutions contain minimal amount free polysaccharide, there will be virtually no deposits between the CNTs, or onto the surface. The polysaccharide coating around a CNT is very thin, basically two atoms thick at any given point, consisting of either hydrogen and carbon or hydrogen and oxygen (FIG. 1 B). In a currently preferred embodiment polysaccharides form a submonolayer on the surface of graphitic material. These factors combined allow good electric contact between the CNTs, and overall electrical conductance of the coating is very good. This is in sharp contrast to the dispersions that are fabricated using detergents. Detergents are used in excess so that the water phase contains micelles, and the CNTs are uniformly coated with detergent molecules that form typically 1-2 nm thick layer. The concentration of the CNTs is typically much less than 8%. Combined these facts mean that the contact between the CNTs is much weaker, when detergents are used.

In the present method the CNTs and polysaccharide are added in small portions so that the stoichiometry is maintained. Stoichiometry is such that the CNTs are coated with a monolayer, or advantageously with a submonolayer, i.e., less than a monolayer. In one currently preferred method the CNTs are first dispersed into water using ultrasonic vibration. The individual CNTs will be partially separated, but van der Waals force between the CNTs keeps them connected into a network that fills most of the water phase (FIG. 2 A). Formation of the network can be observed as an increased viscosity. When polysaccharide is added in small portions, and the mixture is ultrasonically vibrated, the individual polysaccharide molecules wrap around the CNTs so that their mutual van der Waals force will be reduced, and the CNTs will be separated (FIG. 2 B). This is observed as a sudden drop of viscosity. However, if polysaccharide is added suddenly in large quantity, too many polysaccharide molecules wrap around each CNT, and more than a monolayer will be formed. This means that only a segment of each polysaccharide molecule will be in contact with a CNT, and the rest is like a wagging tail (FIG. 2 C).

Although the CNTs will be covered with polysaccharide, and do not have van der Waals contact, the wagging tails bind with each other, and a network will be formed. Also in this case the mixture will have very high viscosity, and the product is clumpy.

Once a low viscosity dispersion is obtained the process can be repeated, i.e., CNTs and polysaccharide can be added in small stoichiometric portions. Thus, the concentration of the CNTs can be increased. Gradually the viscosity will also increase, and will ultimately set a limitation for the concentration that can be achieved. Stoichiometry is not exact concept in this context, and it is better defined as w/w ratio than molar ratio. It is the amount of polysaccharide that is sufficient to form a monolayer or submonolayer on the surface of a CNT so that polysaccharide molecules are essentially bound on the surface of the CNTs, and do not have wagging tails. The optimal polysaccharide/CNT ratio depends on the number of walls in the CNTs, and for SWNTs it is about 1.2-1.5, for DWNTs it is about 1, and for MWNTs it is about 0.3-0.5. These ratios give some guidance, and must be in each case tested experimentally.

When ultrasonic vibration is used for mixing, the viscosity of the mixture must be low at all times during fabrication. The CNTs are advantageously added in portions that do not exceed 0.25% (w/w) of the whole mixture, and polysaccharide is added accordingly in small portions. High pressure microfluidic injection allows much higher transient viscosities, and advantageously 1.5% (w/w) of the CNTs can be added at one time, followed by smaller portions of polysaccharide so that the desired stoichiometry will be obtained. More CNTs and polysaccharide can be added stepwise so that the viscosity of the mixture does not get too high. Each consecutive addition step is advantageously smaller than the previous one. Up to 8% concentration of the CNTs can be obtained by high pressure hydrodynamic injection.

CNTs are bundles that are held together by van der Waals force and are dispersed using polysaccharides and external power source. Graphite is a stack of graphene sheets that is held together mostly by van der Waals force. This stack can be dispersed similarly using polysaccharides and external force.

Hemicelluloses, especially xylan is currently preferred polysaccharide. Currently preferred mixing method is microfluidic injection. Other polysaccharides and mixing methods give good or satisfactory results, and are explained in more detail.

In general SWNTs and DWNTs give significantly better EMI shielding than MWNTs. However, the methods and reagents of this invention will give very good dispersions of MWNTs that are close to performance to that of SWNTs and DWNTs.

Coiled MWNTs provide additional advantage against shielding to magnetic fields. The present invention provides accurate methods for the control of the distribution of the CNTs.

The present invention utilizes molecular details of various dispersion and gelling agents for the dispersion of the CNTs. Understanding of the molecular mechanisms allows the proper choice of components in various phases of manufacturing, storage and application of the CNT dispersions.

We may divide plant polysaccharides and microbial exopolysaccharides roughly into four groups:

1. Cellulose Analogs

Cellulose and analogous molecules have a degree of polymerization of thousands, often about 5000.

Chitosan is glucosamine polymer, i.e., it is like cellulose, in which glucose 2-hydroxyl groups have been replaced by amino groups.

Curdlan consists of glucose, and has 1,3-β-glucosidic bond between two consecutive glucose units. Scleroglucan, and schizophyllan have the same backbone, and in addition glucose containing side groups. Lentinan has also similar backbone, and 1,6-β-glucosidic side groups.

Gellan is here classified as cellulose analog, because it consists of tetramers that have two glucose units bonded by 1,4-β-glucosidic bonds, one glucuronic acid that is also bonded by 1,4-β-glucosidic bond, and one rhamnose that is bonded by 1,3-β-glucosidic bond. These tetramers are bonded by 1,3-β-glucosidic bonds with each other. Accordingly, gellan is anionic cellulose analog. In some sense it is a mix of cellulose and carboxymethyl cellulose (CMC).

Succinoglycan has glucose bonded by 1,3-β-, 1,4-β-, and 1,6-β-glycosidic bonds, and some glucose units are esterified by succinic acid.

Xanthan has cellulose backbone, and side chains that contain 1,2-β-glucosidic bond, glucoronic acid, and some other monosaccharides.

2. Hemicelluloses

Hemicelluloses contain mainly 1,4-β-glucosidic bonds (FIG. 2), and their DP is relatively low from 50 to about 500. Hemicelluloses that are useful for the dispersion of CNTs have DP about 200-500. Their name gives the component monosaccharides:

Glucomannan and galactoglucomannan, arabinoglucuronexylan, xylan, arabinogalactan, rhamnogalcturonan, pectic galactan, arabinan, xyloglucan, and laricinan. All plants contain hemicelluloses, and only most common hemicelluloses are listed here.

Guar gum is classified here as hemicellulose, because backbone consists of 1,4-β-mannose units, and every other mannose binds galactose as a side chain via 1,6-β-glycosidic bond. Using hemicellulose nomenclature guar gum is galactomannan.

3. Starch Analogs

In dextran consists of glucose that in the main chain has 1,6-α-glycosidic bond, and in side chains 1,3-α-glycosidic bond.

In pullulan three glucose units are connected with 1,4-α-glycosidic bond, and these trimeric units are connected with 1,6-α-glycosidic bond. Thus, pullulan is somewhat related to starch.

4. Other

Carrageenan consists of galactose and anhydrogalactose.

Hyalyronan has alternating glucoronic acid and acetyl-glucosamine units.

Levan has 2,6-D-fructofuranosyl units with 2,1-D-fructofuranosyl side chains.

Welan contains L-mannose, and L-rhamnose.

These are most commonly encountered examples, and should not be considered as limitations.

Although trivial name, such as cellulose, is used independently of the plant species, as long as monomer is glucose, and there are no branches, the actual materials can have widely different molecular weights. Similarly, other polysaccharides can have different molecular weights, and in many cases variable branches depending of the biological origin. As a rule of thumb, hard plant materials have higher molecular weights than soft materials. For the purposes of the present invention most polysaccharides should have degrees of polymerization (DP) between 50-5000, advantageously 100-2000, more advantageously 200 -1000.

Many hemicelluloses have DP between 100-500. Shorter polysaccharides have low affinity for the CNTs, while long ones are difficult to disperse.

These natural polysaccharides may be further functionalized, for example, carboxymethyl groups may be introduced by reaction with 2-chloroacetic acid under alkaline condition. It is often preferable to use limited amount of functionalization so that only one moiety, such as glucose, out of 3-8 moieties will be functionalized. Several functional groups and methods to introduce them are well known in-the-art. Functional groups will affect the optimum DP. For hydrophobic groups optimal DP is smaller, while the opposite is true for hydrophilic groups.

Good dispersion of CNTs depends on two factors. First, the dispersant must wrap around the CNTs so that they will be separated. Second, the dispersant must prevent the recombination of the CNTs. Dispersion is best achieved, if the viscosity of the medium will be low. Recombination is avoided, if the viscosity is high. Ideally, one dispersant should be enough. However, it might be easier to find a combination of two compounds that will work better than one. Short polysaccharides have lower viscosity than long ones. Branching tends to add viscosity. For example, cellulose, or cellulose derivatives, such as microcrystalline cellulose, nano cellulose, have been used to disperse CNTs (Moilanen and Virtanen, PCT/FI10/00077, and the references therein). These contain β-glucose that is as planar as a monosaccharide can be (FIG. 1 A, R═CH2OH). Thus, the fit between polysaccharides that contain β-glucose is as good as it can be between the CNTs and polysaccharides. Several hydroxyl groups and glycosidic oxygen atoms will reduce interfacial surface tension. These two factors make β-glucose containing polysaccharides good dispersants for the CNTs. In the present invention it has been found that hemicelluloses that have horizontally oriented oxygen atoms (FIG. 1 A) are even better dispersants for the CNTs than cellulose derivatives. Xylose is a pentose that is stereochemically analogous to glucose (FIG. 1 A, R═H). Rhamnose has the same stereochemistry as glucose, but 6-hydroxyl is missing, i.e., there is a methyl group in 6-position (FIG. 1 A, R═Me). Glucuronic acid has the same stereochemistry as glucose, but has carboxylic group in 6-position (FIG. 1 A, R═COOH). Rhamnose is more lipophilic than glucose, while glucuronic acid is more polar, especially at high pH. Although glucuronic acid containing polysaccharides will be good dispersants for the CNTs, we have found that static negative charges are slightly detrimental for the conductivity of the CNTs. Of all polysaccharides tested we have found that hemicelluloses give the best low viscosity dispersions. Currently preferred hemicelluloses contain at least 80% of xylose, glucose, or rhamnose in their backbone.

MWNT-xylan nanocomposite has very good electrical properties, specific resistance is 0.002Ω*cm. DWNT-xylan can have specific resistance of 250 μΩ*m. These are significantly better values than obtained by CNT-cellulose nanocomposites (Moilanen and Virtanen PCT/FI10/00077).

Correspondingly EMI shielding efficacy of CNT-xylan nanocomposites is one or even three orders of magnitude better than that of CNT-cellulose nanocomposites.

Electrical conductivity benefits from periodic regular structure that is encountered in metals, and also in CNTs. However, CNTs are sensitive to the surroundings, and it is preferable that they are surrounded by a material that has regular periodic structure. While most polysaccharides have periodic backbone, their side chains may have variable composition, and location. Some have also regular side chain composition, and periodic location. Some synthetic cellulose derivatives may also also periodic. These include hydroxyethyl cellulose, and carboxymethyl cellulose (CMC). Although CMC is very good dispersant for the CNTs, and has previously considered to give good electrically conducting films, we have found that the conductivity, and EMI protection obtained is superior by using instead some polysaccharides. It appears that stationary electrical charges of ionic bonds in CMC have surrounding local electrical fields that disturb movement of conducting electrons. Accordingly, in the currently preferred embodiments of this invention, excessive localized charged species will be avoided.

Also conventional detergents might be used in very small amounts for the dispersion of the CNTs in conjunction of the present invention. These include octyl glucoside, dodecyl sulphate, tween, and triton. Detergents affect minimally viscosity of water, and can even decrease viscosity. This is very important for the early stages of the dispersion. Detergents help also wetting of surfaces, when CNT-polysaccharide solution is applied for film making. Fluoropolymers are especially advantageous in that regard. Their concentration may be advantageously 0.001-0.01%.

Starch or exopolysaccharide that is classified as a starch analog above could be used for the gel formation in order to increase the viscosity. They have α-glycosidic bonds that make them flexible. They are not the first choice for dispersion, but can be used to increase viscosity. Because of their flexibility they will fill voids and have glue-like properties, and will contribute to the integrity of coatings. Mannan and some other hemicelluloses can equally well be used to increase viscosity. Carrageenan is ideally thixotropic. It forms a gel during storage, but during mixing it will be fluid. Also polyacrylates are good fillers and binding agents both for the substrate and for the integrity of the coating. Polyacrylate gel that is polymerized during the dispersion is an “ultimate” gelling agent and will prevent reaggregation of the CNTs. Other additives include polyvinyl alcohol (PVA), and glycerol. Especially high molecular weight PVA will improve the integrity of the film made of CNT-polysaccharide. Glycerol is a softener that allows the film to reorganize to some extent even after water has evaporated.

Although commercially available polysaccharides give good results in many cases, purification of polysaccharide may be necessary sometimes. Impurities are often proteins, and other biomolecules.

We have also extracted hemicelluloses from natural sources:
1. Finely ground plant material is dispersed into about 100-fold amount of 60° C. water.
2. The mixture is sonicated in a bath sonicator about 1 hour.
3. The mixture is filtered.
4. The plant material is dispersed into 0.1 M sodium hydroxide.
5. The mixture is sonicated in a bath sonicator about 1 hour.
6. The mixture is filtered.
7. Into the filtrate is added an equal amount of 2-propanol.
8. The mixture is filtered, and the solid hemicellulose is collected.

The first water extraction removes water soluble proteins, and smaller carbohydrates. Steps 1-3 can be skipped especially, if the product is further purified just by dissolving it into water, and precipitating with 2-propanol.

Fabrication of CNT Dispersions

One currently preferred method of this invention consists of the following steps:
1. CNTs are added into dilute solution of an alcohol (about 5%) in water
2. The mixture is ultrasonically vibrated or hydrodynamically mixed.
3. β-Glucose, β-xylose, or β-rhamnose containing polysaccharide is added in small portions.
4. α-Glycosidic bonds containing polysaccharide and/or polyacrylate is added.

The initial dispersion is efficient using ultrasonic vibration, because the viscosity is low. Interestingly, the viscosity of CNTs alone and polysaccharide alone is typically much higher than viscosity of their complex.

The final coating that avoids the problems associated with detergent coating is achieved by adding polysaccharides that have high affinity for the CNTs. These polysaccharides have high content of β-glycosidic bonds, more than 50%, advantageously more than 75%.

Because only a small portion of polysaccharide will be added, virtually all molecules will wrap around the CNTs, and they will not form viscous gel. Instead of bath type addition, addition can be performed continuously. Also two different polysaccharide components can be added so that one is a weak gelling agent, while the other forms very viscous gel. Gel formation is favored by side chains, and moderate charges. Thus, neat cellulose is relatively weak gel forming agent, while xanthan is strong gelling agent. The total mass ratio of the CNTs and polysaccharides during dispersion is advantageously between 80:20 and 5:95, most advantageously the ratio is between 75:25 and 65:35 for MWNTs, and 65:35 and 50:50 for DWNTs, and 50:50 and 40:60 for SWNTs. These amounts of polysaccharide are enough to form a monolayer around the CNTs.

This method provides about 1% dispersion of CNTs in water that has still low viscosity. Stepwise addition of polysaccharides is essential for the formation of good quality dispersion especially, if ultrasonic vibration is used for the dispersion. If higher concentration of CNTs is wanted, as is often the case in practical applications, stepwise addition of the CNTs is also essential. The concentration of CNTs can increased from 1% to 2% by adding CNTs on small portions, for example, in five portions. After each addition a polysaccharide is added preferably in small portions. Of course, the process can be automated so that the additions are continuous. By this procedure the viscosity of the 2% dispersion is still low. Also electrical conductivity of the coating can be extremely good, for example, specific resistance can be as low as 300 μΩ*m, when DWNTs and xylan are used.

The stepwise dispersion is really essential for good quality dispersion of the CNTs using polysaccharides as dispersants. Every other method that inventors have tried has resulted into clumpy “porridge” that gives poor coatings, and higher resistance. The observation can be explained in a following way that should not be considered as a limitation of the present invention. The CNTs are first dispersed into water using no or minimal amount of dispersant. This preliminary dispersion breaks bundles to some extent, and increases the available surface area of the CNTs. When a small portion of polysaccharide is added, it can bind fast with the exposed surface, and facilitate further detachment of the CNTs from the bundles so that new surface is exposed etc. The dispersion is fairly viscous as long as the CNTs are partially bound with each other. However, when they are totally covered by polysaccharides, the viscosity drops suddenly close to that of water. Polysaccharides that are wrapped around of the cylindrical CNTs will not bind strongly with each other.

When dispersion is complete, further gelling agent may be added. This is advantageously starch or some analogous compound that contains more than 50% α-glycosidic bonds, advantageously more than 75%. Alternatively mannan or xanthan may be used for the gel formation. These gels are thixotropic, i.e., the viscosity depends on the shear rate.

The gels can be very viscous, if they have been undisturbed long time in cold. Mixing makes them much more fluid, because hydrogen bonded network will be cut into smaller units. Thus, strong mechanical mixing and/or high temperature during ultrasonic vibration is recommended. High pressure hydrodynamic mixing in microfluidic chamber is another efficient mixing method. Advantageously, two opposite nozzles will be used so that two streams collide with each other.

Coating of 3D structures is enabled by using thixotropic polysaccharides or other compounds, such as carrageenan, and mannan, because there will be minimal flow after coating. In addition of mixing just before or during coating, the mixture may be heated so that hydrogen bonds will be mostly disrupted. After the mixture is spread onto a surface it will cool down and settle very fast.

Also some other polymers may be used so that coating properties will be improved. Currently, various polyacrylates, and polyvinyl alcohol are favored.

Still another way to improve stability is to add acrylic acid, divinyl acetic acid, and persulfate. These may be added before the end of dispersion. Acrylic gel will be formed that will almost completely prevent the aggregation of the CNTs. Acrylic gel may be cut into thin sheets or other shapes. They can be dried in grid molds into desired shapes.

Because polysaccharides contain multiple hydroxylic groups, the stability of films can be increased by esterification with boric, dicarboxylic, or polycarboxylic acid. Currently, succinic and citric acids are preferred. Boric acid reacts at room temperature, if the solution is basic. Carboxylic acids require heating at about 100-120° C. Heating and cross-linking is actually beneficial for the conductivity of the films.

Doping with known agents, such as nitrogen dioxide or thionyl chloride is another possibility. They are unstable dopants.

Applications

The present method has several significant advantages over conventional methods. First, the viscosity of the medium will be minimal during the fabrication that will allow high loading of the CNTs. Polysaccharides are useful, because higher CNT concentration are possible than with conventional detergents. More importantly, polysaccharides provide thin and polar coating for the CNTs. This is important for many applications, including supercapacitors, EMI shields, stealth coatings, transparent conducting films, and heating elements, because the CNTs can still have enough contact point for good electrical conductance. Coiled CNTs have good magnetic shielding properties.

These dispersion can be used in all applications that have been described for CNT-cellulose dispersion. In addition there are some new applications.

In most applications the CNT dispersion will be spread on a solid surface. Many painting and printing methods can be used. One currently preferred method is spraying. Commonly nozzles will be used. Ultrasonic vibration enables nozzle free spraying. This may be important, if the concentration and viscosity is very high. Ultrasonic vibration may also be used with nozzles. Other spraying techniques include gas pressure assisted spraying and electrospraying. Currently, electrospray is favored, because the CNTs will be (preferably negatively) charged. Charged CNTs will be maximally separated inside a tube, and ideally also oriented. Orientation can be further assisted by external additional electric field that can be static or oscillating. While the CNTs are ideally totally separated inside a tube, they will overlap with each other, when the tube is dried on the surface and/or other tubes are deposited on the surface. The combination of dispersion agent, method, CNT:dispersion agent ratio, and deposition method will allow control of CNT spacing in the coating layer.

A given surface can be painted by multiple layers that have different conductivities. For example, the top layer may have surface resistance of 377 Ω so that theoretically no electromagnetic radiation is reflected back. Next layer may have higher concentration of CNTs so that absorption is more efficient, etc. The lowest layer may have the CNT concentration about 75% so that virtually all radiation will be absorbed. This kind of coating will give optimal stealth properties for the object, and can be used in military applications, and as well in EMI protected rooms, and wind mill towers, and blades so that they do not disturb radar signal.

EMI shielding properties of the present material are excellent. For example, 60 μm layer will give about 60 dB shield against electromagnetic radiation over frequency range 0-18 GHz. However, shield against magnetic field is minimal between 0-400 MHz. While this is a drawback in many EMI shield applications, it can be very useful and unique property, when inductive charging of batteries will be used. For instance, cell phones may be totally protected against electromagnetic interference, and their batteries can be still inductively charged. This kind of EMI shield has wide applications also in other devices. While present material provides extremely good EMI shield, other materials that contain CNTs have similar properties. Thus, CNTs can be incorporated into plastic casing or other parts in order to obtain EMI shield, while allowing low frequency magnetic field to penetrate.

The wall of EMI protected rooms are often covered by electromagnetic radiation absorbers. Typically, but not necessarily these are cone shaped, and made of polyurethane. Polyurethane is porous, and can be loaded with carbon black or graphite containing material. The present material can be ideally used for polyurethane, and, other kind of absorbers.

Interaction between polyurethane and polysaccharides is very good, because multiple hydrogen bonds between molecules. Polyurethane foam will be soaked in 0.01%-3% CNT-polysaccharide dispersion. Excess of the CNT dispersion is compressed out, and polyurethane is dried in an oven. Optionally, the CNT dispersion may be saturated with boric acid that is fire retardant. Thus, fabrication of fire resistant absorbers will require only one soaking and drying step.

Low power charging station can be made nearly universal for all mobile devices by adapting a global standard WPT Specification that is given as a reference. Universal charging of all mobile devices by one charger requires communication between the mobile device and charger regarding power level, received power, temperature, and charging time. This communication is performed also magnetically. Thus, the charger and device transmit and receive only oscillating magnetic field. Magnetic field has currently a frequency between 110-205 kHz. All oscillating electric circuits generate also electromagnetic radiation. It would be beneficial, if electromagnetic radiation could be contained within charger, while oscillating magnetic field could reach the device unattenuated. Metals cannot be used, because they absorb both electromagnetic radiation and oscillating magnetic field efficiently. Similarly, graphite, and antrasene are not suitable for wireless power transfer. We have found that carbon nanotubes have ideal properties for this purpose. They provide excellent EMI shielding, while are permeable to magnetic fields that are used in charging stations. This property is obviously due to their curvature and relatively small diameter. Those features do not favor eddy currents that attenuate oscillating magnetic field.

All types of CNTs can be used. Multi walled carbon nanotubes (MWNTs) are most economical, and easiest to disperse into various compositions. Single walled carbon nanotubes (SWNTs) are currently expensive, and difficult to disperse in high enough concentrations. Double walled carbon nanotubes (DWNTs) can be also easily dispersed, and have very good EMI shielding performance, and also good H-field shielding at higher frequencies, above 1 GHz. From technological standpoint DWNTs are currently preferred.

A charger is covered by a shield that typically is flat so that the distance between the primary and secondary coils can be minimized. That shield is made of plastic or some other material that allows the oscillating magnetic field to reach the secondary coil unattenuated. CNTs can be incorporated into that shield, or one or both surfaces of the shield can be coated with the material that contains CNTs. Currently coating of the underside of the shield is preferred. Still another alternative is to make a sandwich structure, in which the CNT layer is between two plastic plates.

Another new application is to use these graphitic dispersions in heat exchangers, either for heating or cooling purposes.

For example, in power plants coolant is pumped through heat exchanger. Heat is mainly exchanged by a surface contact between liquid and a solid surface. However, close to the surface the flow of the liquid is very slow.

Radiative heat exchange is far from optimal, because metals reflect IR radiation. Graphitic materials are extremely good thermal conductors, but as such are not good IR absorbers, or radiators, because their vibrational states are mostly symmetric. However, if these materials are coated with molecules, or particles that absorb, or radiate heat effectively, the heat energy that they collect from the milieu will be very fast transferred to the radiating molecules, or particles. The solid surface that will receive the radiation can be painted with the materials of this invention, so that the radiation will be absorbed and transferred through the wall of the heat exchanger to another cooling material that may be liquid or gas. The heat exchange wall may be painted on the both sides with the material of this invention so that absorption, or radiation is effective on both sides.

The materials of this invention can be used to fabricate supercapacitors with the same methods than has been described earlier (Moilanen and Virtanen, PCT/FI10/00077). However, because the present materials are dispersed in water very easily, cross-linking is advantageously used in water containing supercapacitors. The specific capacitances are 20 to 45% higher than those obtained by CNT-cellulose supercapacitors.

### EXPERIMENTAL DETAILS

While this invention has been described in detail with reference to certain examples and illustrations of the invention, it should be appreciated that the present invention is not limited to the precise examples. Rather, in view of the present disclosure, many modifications and variations would present themselves to those skilled in the art without departing from the scope and spirit of this invention. The examples provided are set forth to aid in an understanding of the invention but are not intended to, and should not be construed to limit in any way the present invention.

### Example 1

1 g of MWNTs were added into 100 ml of ethanol/water 5:95 mixture. The mixture was ultrasonically vibrated (200 W), and 1 g of xylan was added in 0.1 g portions during one hour.

This dispersion was spread on a polycarbonate sheet as a 20 μm film (after drying) using silk printing method. Specific resistance of the film was 0.0045 Ω*cm, and EMI shielding was 40 to 60 dB between 1-18 GHz.

### Example 2

2 g of MWNTs were added into 200 ml of water. The mixture was hydrodynamically processed (LV1 Microfluidizer Processor IDEX Material Processing Technologies Group), and 0.75 g of xylan was added in 0.25 g portions during ten minutes, and 0.75 g of mannan was added during ten minutes.

This dispersion was spread on a polycarbonate sheet as a 20 μm film (after drying) using silk printing method. Specific resistance of the film was 0.002 Ω*cm, and EMI shielding was 40 to 50 dB between 1-18 GHz.

### Example 3

1 g of MWNTs were added into 100 ml of water. The mixture was ultrasonically vibrated (200 W), and 0.4 g of xylan was added in 0.08 g portions during ten minutes. This dispersion vas further diluted ten fold. Polyurethane foam cube (side 5 cm) was soaked in the CNT dispersion, and excess of liquid was compressed out. Polyurethane still contained 5.4 g of CNT dispersion, and was dried overnight in 90° C. oven. Polyurethane had specific resistance of 24 Ω*cm.

### Example 4

1% CNT dispersion in water was prepared using 0.4% xylan as dispersant. Into this dispersion was added using mechanical mixing 2 g of graphite powder (200 mesh, Alfa Aesar). The crude graphite dispersion was processed with LV1 Microfluidizer Processor IDEX Material Processing Technologies Group) three times using 2 500 bar pressure. The viscosity increased each time, and the product was very viscous after the third treatment. A film was cast on plastic substrate. Specific resistance of that film was 2410 μΩ*m.

### Example 5

Cellulose (10 g) and graphite powder (10 g) were dispersed into water by mechanical mixing. The crude graphite dispersion was processed with LV1 Microfluidizer Processor IDEX Material Processing Technologies Group) three times using 2 500 bar pressure. The viscosity increased each time, and the product was very viscous after the third treatment.

### Example 6

20 mg of DWNTs (Unidym, Sunnyvale, California) were added into 200 ml of water. The mixture was hydrodynamically processed (LV1 Microfluidizer Processor IDEX Material Processing Technologies Group), and 20 mg g of xylan was added. After three cycles polycarbonate sheet was covered with 0.2 mm thick layer, and dried. Transmittance was over 90%, and surface resistance under 100 Ω/sq.

### FIGURE CAPTIONS

FIG. 1.

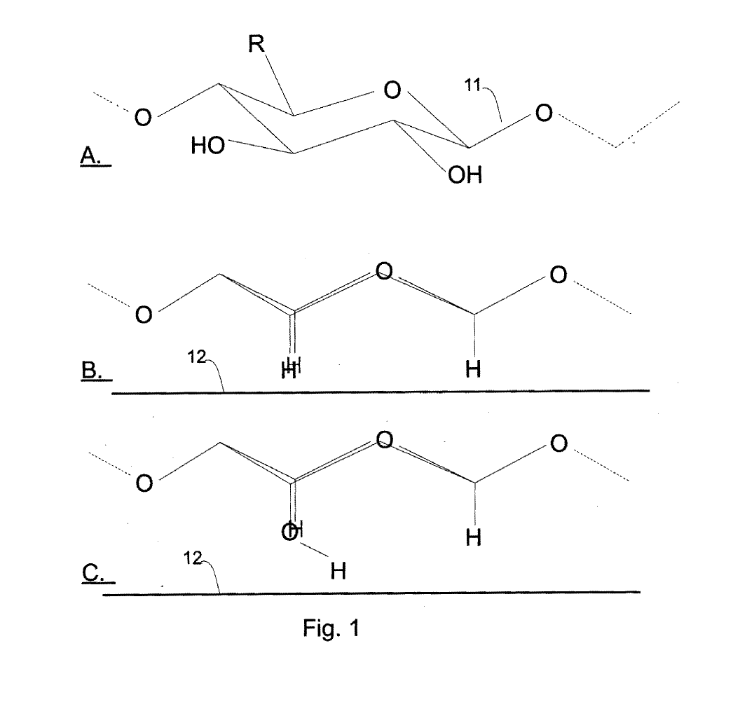

A. Monomeric unit of a polysaccharide that has 1,4-α-glycosidic bond 11, and 2-, and 3-hydroxyl groups attached with are horizontal, and also the group R is also horizontal.

B. Sideview of the monomeric unit. For the clarity hydroxyl groups are not shown, because they overlap with the backbone. The line 12 represents the surface of a graphitic material.

C. Sideview of a monomeric unit that has one hydroxyl group axial. Polysaccharides that contain these kind of monomeric units in the backbone are poor dispersion agents.

FIG. 2.

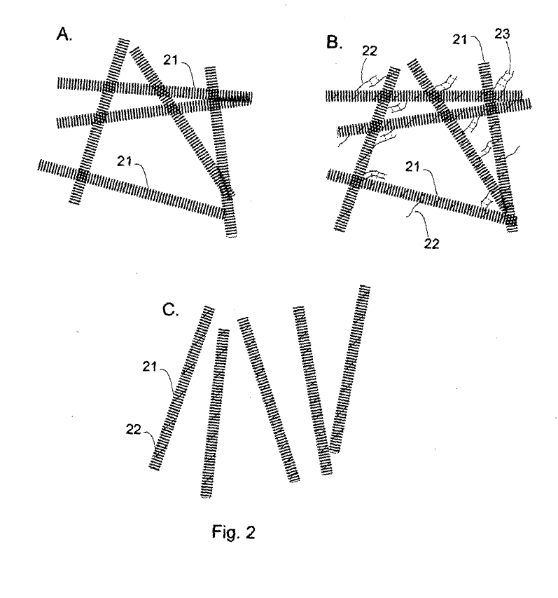

A. A network of CNTs that forms initially, when the MWNTs 21 are dispersed into water without any dispersion agent, and are bound by hydrophobic force.

B. A hydrogen bonded 23 network that is formed, when too much polysaccharide 22 is added or it is added too fast.

C. The dispersion of this invention, in which the CNTs are effectively dispersed.

FIG. 3. EMI shielding efficiency of a 20 μm thick film.

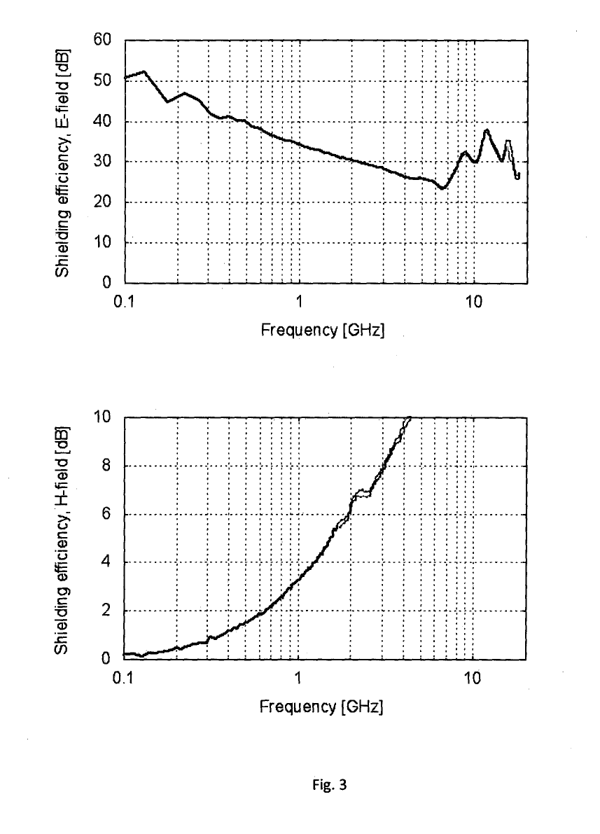

What is claimed is:

1. A method for the dispersion of carbon nanotubes, or graphene using external energy source for mixing, and known for the use of a hemicellulose that contains more than 80% of glucose, xylose, or rhamnose in the backbone as a dispersion agent, and does not have static ionic electrical charges.

2. A method of claim 1, in which the said hemicellulose is xylan.

3. A method of claim 1, in which the said mixing is ultrasonic vibration.

4. A method of claim 1, in which the said mixing is hydrodynamic injection of the mixture.

5. A dispersion that is fabricated using the method of claim 2.

6. A dispersion of claim 5, in which is fabricated using double walled carbon nanotubes.

7. An electromagnetic interference shield fabricated using the dispersion of claim 5.

8. A stealth coating fabricated using the dispersion of claim 5.

9. An electrically conducting and transparent coating that is fabricated using the dispersion of claim 6.

10. A surface coating fabricated from the dispersion of claim 5, which is cross-linked using boric acid, dicarboxylic acid, or citric acid.

11. A supercapacitor fabricated using the cross-linked material of claim 10.

12. A heat exchanger fabricated using the cross-linked material of claim 10.

13. A dispersion of claim 5, which contains polyvinyl alcohol, starch, carrageenan, or mannan.

14. A dispersion of claim 5, which has been stabilized using polyacrylate gel.

15. A method for the extraction of hemicelluloses from plant materials, known for the use of ultrasonic vibration during the extraction process.
